(19) United States
(12) Patent Application Publication
(10) Pub. No.: US 2025/0376399 A1
(43) Pub. Date: Dec. 11, 2025

(54) WATER TREATMENT SYSTEM FOR PRODUCING OXYGEN DEPLETED, DRIED STEAM AND PROCESS FOR PRODUCING IT

(71) Applicant: Topsoe A/S

(72) Inventors: Troels Dahlgaard STUMMANN, Valby (DK); Johannes QUINTERO, Copenhagen S (DK); Ilayaraja KARUPPASAMY, Gentofte (DK)

(73) Assignee: Topsoe A/S, Kgs. Lyngby (DK)

(21) Appl. No.: 18/878,987

(22) PCT Filed: Jun. 22, 2023
(86) PCT No.: PCT/EP2023/066941

§ 371 Date: Dec. 26, 2024

(30) Foreign Application Priority Data
Jul. 15, 2022 (EP) 22185119.9

(51) Int. Cl. C02F 9/00; C02F 1/04; C02F 1/20; C02F 1/42; C25B 1/042

(52) U.S. Cl. CPC C02F 9/00; C25B 1/042; C02F 1/04; C02F 1/20; C02F 1/42; C02F 2209/02; C02F 2209/03; C02F 2209/40

(57) ABSTRACT

The present invention regards an improved water treatment system and a water treatment process for producing an oxygen depleted, dried process steam suitable for use in high-temperature solid oxide electrolysis. The system and the process has been simplified compared to prior art systems and processes.

### FIELD

The present invention regards an improved water treatment system and a water treatment process for producing an oxygen depleted, dried process steam suitable for use in high-temperature solid oxide electrolysis.

### BACKGROUND

The climate change has accelerated a worldwide transition from fossil fuels to renewable energy sources. Typically, the renewable energy comes from wind and solar power generation. The challenge with renewable energy is its intermittent nature.

Power-to-X (PtX) is a term used for electricity conversion, energy storage, and reconversion pathways that use electric power. Power-to-X conversion technologies allow for the decoupling of power from the electricity sector for use in other sectors (such as transport or chemicals) and have the ability to eliminate problems with fluctuating renewable energy generation.

At present, electrolysis is the core technology of PtX solutions, where X typically is hydrogen, syngas, chemicals or synthetic fuels. When electrolysis is combined with renewable electricity, the production of fuels and chemicals can be decoupled from fossil resources.

Solid oxide electrolysis (SOE) technology is particularly attractive for this because of higher conversion efficiencies than low-temperature electrolysis—as a result of favorable thermodynamics and kinetics at higher operating temperatures.

SOECs can be used for direct electrochemical conversion of steam (H₂O), carbon dioxide (CO₂), or both into hydrogen (H₂), carbon monoxide (CO), or syngas (H₂+CO), respectively.

SOECs can be thermally integrated with a range of chemical syntheses, enabling recycling of captured CO₂ and H₂O into synthetic natural gas, gasoline, methanol, or ammonia, resulting in further efficiency improvements compared with low-temperature electrolysis technologies.

The splitting of H₂O or CO₂ occurs at solid oxide electrolysis cell (SOEC) electrodes. Multiple cells are combined into SOEC stacks, and multiple stacks are in turn combined into an SOEC plant.

The fuel (H₂O and/or CO₂) enters the process side of the SOEC where it is (partly) converted into the product (H₂, CO or syngas). The oxygen produced in the conversion on the fuel side is transferred through the electrochemical cell to the oxy side of the SOEC, where it is recombined as gaseous oxygen. It is typically transported away from the SOEC with a flush fluid.

A solid oxide cell (SOC) is an electrochemical conversion device having two compartments (an anode side and a cathode side) divided by an electrolyte material made of a solid oxide or a ceramic electrolyte. It may be used as a solid oxide electrolysis cell (SOEC) or as a solid oxide fuel cell (SOFC). Such a cell is fully reversible e.g. for the components H₂O<->H₂ and CO₂<->CO and for mixtures thereof.

When operated in SOEC mode, the goal is to produce H₂, CO or mixtures of H₂ and CO (also referred to as synthesis gas)—and the quality of the converted gas, also called the product gas (or product fluid) may be critical for downstream applications. It is thus desirable to minimize the presence of undesired components (e.g. air) in the product fluid to obtain a high purity product fluid.

An SOEC plant generally comprises multiple stacks connected in parallel and/or series in an amount to meet the required production needs. In SOEC mode, the cathode side may also be referred to as the fuel side and the anode side may also be referred to as the oxy side or the flush side.

There is a lot of focus on optimizing the performance of the SOEC technology by increasing the efficiency of the electrolysis stacks. However, optimization of the process equipment supporting the SOEC stacks is equally important. Optimizing the design of an SOEC-based plant is a balance between complexity of the process, energy consumption per unit of product gas and the costs of producing the equipment.

For some of the uses of SOEC, steam is required as one of the feeds. It is generally known to expose a water stream to some kind of water treatment prior to using it in industrial systems (may be referred to as a process steam). Untreated water may contain impurities causing damage or wear to the system. Such impurities may cause formation of scales, corrosion, deposits etc. Also, oxygen may be unwanted in the process steam since it may cause corrosion, e.g. in piping and heat exchangers. Furthermore droplets/entrainment are unwanted due to high concentration of impurities in the boiler water. This is the case for e.g. uses in SOEC. Generally, raw water is treated first in an ion-exchanger to remove minerals. Demineralized water is then passed through a deaerator to produce deaerated water which is then passed to a boiler with a steam drum where dry steam is produced, which is then ready for use as a process steam. In the deaerator oxygen is stripped from the water and the stripped water is collected in a surge vessel. In the boiler, the deaerated water is heated in a heat exchanger and the heated mixture of water and steam is then separated in a steam drum to produce the dry steam for use as feed. Such representative prior art water treatment systems have been illustrated in FIGS. 6 and 7.

There is still a need for optimizing the performance of SOEC plants to improve the industrial applicability and the rentability of such both for producing hydrogen, carbon monoxide and synthesis gas.

### SUMMARY OF INVENTION

The inventors have now developed a simplified water treatment system for treating water or demineralized water to produce oxygen depleted, dried process steam suitable for use in e.g. solid oxide electrolysis.

In one aspect of the invention there is provided a water treatment system for preparing an oxygen depleted, dried process steam (35) comprising:
a stripper (21) for stripping oxygen from water;
a fluid collector vessel for collecting oxygen depleted, liquid water from the stripper;
a fluid separator vessel for collecting a liquid water-steam mixture and for separating water from steam;
a heating arrangement for vaporizing liquid water to steam; and
wherein said fluid collector and said fluid separator are provided as a combined vessel (22) for collecting oxygen depleted liquid water from the stripper (21) and for separating water and steam; and
wherein said stripper (21) is arranged above and in direct fluid communication with said combined vessel (22); and
wherein said heating arrangement is arranged to provide steam to the lower part of the combined vessel (22).

The heating arrangement comprises heating element which may be arranged below and in direct fluid communication with said combined vessel (22) and/or the heating elements may be arranged within and in the lower part of the combined vessel (22).

In one aspect of the invention there is provided a water treatment process for producing an oxygen depleted, dried process steam comprising the steps of:
Stripping oxygen from a demineralized water stream by passing it over a packed bed and passing oxygen stripping steam in a counter current direction to produce oxygen depleted water;
Collecting the oxygen depleted water in a combined vessel to obtain an oxygen depleted water-steam mixture within the combined vessel;
Indirectly heating a liquid part of the water-steam mixture to produce wet steam;
Removing water droplets from the wet steam by bubbling the steam through the liquid part of the water-steam mixture to produce dried steam;
wherein the oxygen depleted water-steam mixture within the combined vessel serves to supply the oxygen stripping steam to the stripper, to buffer variations in the demineralized water stream per dried steam produced, to absorb differences in pressure upstream versus downstream of the combined vessel, and to remove water droplets from the wet steam; to produce the oxygen depleted, dried process steam.

In one aspect there is provided a use of the apparatus according to the invention in a plant using steam as a feed.

In one aspect there is provided a process for producing hydrogen comprising:
Producing oxygen depleted, dried process steam according to the water treatment process for producing an oxygen depleted, dried process steam according to the invention;
Feeding the oxygen depleted, dried process steam to a solid oxide electrolysis cell and performing high temperature electrolysis within the cell to produce a hydrogen rich product gas.

The water treatment system according to the invention simplifies the plant setup for operating a high-temperature solid oxide electrolysis plant to produce e.g hydrogen gas or combined hydrogen and carbon monoxide gas. In particular, the invention enables the construction costs of the system. Since two vessels are combined into a single combined vessel, less metal is required for the reactors and less instruments are needed for controlling the operation of the system. Combining the surge vessel of the deaerator with the steam drum of the boiler into a combined vessel is particularly convenient if the electrolysis system is operated at moderate pressures such that any pressure fluctuations within the high-temperature electrolysis plant during operation in general are not too large.

### LEGENDS TO THE FIGURES

FIG. 1 shows an embodiment of the water treatment system according to the invention.

FIG. 2 shows an embodiment of the water treatment system according to the invention.

FIG. 3 shows an embodiment of the water treatment system according to the invention.

FIG. 4 shows an embodiment of the water treatment system according to the invention.

FIG. 5 shows an embodiment of the water treatment system according to the invention.

FIG. 6 shows a prior art water treatment system.

FIG. 7 shows a prior art water treatment system.

### DETAILED DESCRIPTION OF THE INVENTION

Disclosed herein is a water treatment system as defined above.

The present inventors surprisingly found that in high-temperature, solid oxide electrolysis, it was possible to simplify the water treatment system for producing process steam compared to prior art water treatment systems. In particular, they found that instead of passing demineralized water first through a deaerator comprising a stripper and a surge vessel and then through a boiler comprising a steam drum and a heating arrangement it was possible to combine the functions of the surge vessel with the functions of the steam drum into a combined vessel. They thus found that the stripper could be connected to the upper part of the combined vessel and the heating arrangement could be connected to the lower part of the combined vessel such that during operation the liquid phase (boiler water) inside the combined vessel could be heated by the heating arrangement to produce steam to the bottom of the combined vessel and the steam thus rising through the boiler water within the combined vessel to remove entrained water droplets from the steam could be used as steam supply to the stripper as well as for dried process steam exiting the upper part of the combined vessel. They also found that such simplification had many benefits. For example, an entire vessel can be dispensed with. This reduces not only the amount of metal used for constructing a plant, but also reduces piping requirements, process control requirements, heating requirements etc.

When referring to the lower part or the bottom of the combined vessel, this is meant to refer to the part of the vessel which is occupied by a liquid phase when in operation. When referring to the upper part or the top of the combined vessel, this is meant to refer to the part of the vessel which is occupied by a vapour phase when in operation. This exact height of the liquid surface may vary a bit while the system is in operation.

In the present context the process steam is referred to as dried steam meaning that liquid drops of water entrained in the steam have been removed. In practice such dried steam is referred to as “dry” steam. Water droplets are potentially harmful since they can contain high concentrations of impurities which have accumulated in the liquid phase of the liquid drum.

In the prior art the understanding has been that water treatment for producing process steam is carried out by first removing minerals in a demineralizer, then removing oxygen in a deaerator and finally producing dry steam in a boiler. The deaerator normally comprises a stripper and a surge vessel for collecting the deaerated liquid as well as for absorbing surges in pressure. The boiler normally comprises a heating element and a steam drum for separating liquid drops of water from the steam as well as for absorbing surges in pressure.

Accordingly, a “surge vessel” is a fluid collector vessel which in the present context is to be understood as a vessel arranged to contain a buffer volume of a fluid (in the present context liquid water). The buffer volume serves to cover variations in feed flow to the vessel and in product flow out of the vessel. The buffer volume should preferably both serve to cover flow variations caused by slow action process control of the liquid level in the vessel, and to provide a volume of liquid allowing differences in operating pressures as well as preventing any fluctuations in operating pressures upstream vs downstream of the surge vessel thus allowing safe operation of the process. In other words a surge vessel serves as a water buffer and to absorb surges of pressure upstream or downstream of the surge vessel. The stripper with the packed bed may be integrated with the surge vessel, and may then be referred to as a “deaerator”.

A “steam drum” is a fluid separator vessel which in the present context is to be understood as a vessel arranged to store steam and to separate a dried (i.e. saturated) steam from a steam-water mixture. The steam-water mixture is fluidly connected with a heating arrangement providing indirect heating for generating steam. Generally, the heating arrangement includes heating elements in the form of heat exchangers, but the heating elements may also comprise a heating coil within the steam drum providing heat to the water. The steam generated by the heating arrangement passes through a buffer volume of fluid (in the present context liquid water) contained in the steam drum which serves to condense liquid water droplets present in the generated steam thus creating dried steam and also to cover variations in feed flow to the vessel and in product flow out of the vessel. The buffer volume should preferably both serve to cover flow variations caused by slow action process control of the liquid level in the vessel, and to provide a volume of liquid allowing differences in operating pressures as well as preventing any fluctuations in operating pressures upstream vs downstream of the steam drum thus allowing safe operation of the process. The buffer volume should also be sufficient to secure that heat surfaces of the heating arrangement are always covered by water also during startup and shutdown of the system (such as due to deficit of feed water). A difference in densities between hotter and colder water helps in the accumulation of the “hotter” water and dried steam in the top of the steam drum and the colder water will sink to the lower part of the vessel. In other words, a steam drum serves to separate water droplets from the steam, it serves as a water buffer covering flow variations, ensuring that heating surfaces are covered, and it serves to absorb surges in pressure as well as to store the steam generated.

### The Stripper

In the context of water treatment, the purpose of the stripper is generally to strip oxygen from a liquid water feed (liquid phase). The stripping may be obtained by passing steam (vapour phase) upwardly through the stripper while the liquid water feed passes downwardly through the stripper allowing oxygen to pass from the liquid phase to the vapour phase. As the skilled person will know, it is desirable to arrange the internals of the stripper to obtain a large liquid surface. As the skilled person will also know it is desirable to let the stripper extend upwardly to allow a reasonable contact time between the liquid phase and the vapour phase.

Generally, the stripper (21) comprises a packed bed, baffles and/or other internals to accommodate stripping of oxygen from liquid water within the stripper (21). Generally, the stripper (21) comprises a liquid water inlet arranged in the upper part of the stripper. Generally, the stripper (21) comprises a vapor outlet arranged in the upper part of the stripper.

### The Combined Vessel

When in operation, the combined vessel will comprise a liquid phase in the lower part of the combined vessel and a vapour phase in the upper part of the combined vessel. The liquid phase will form a buffer volume of liquid, which also serves to remove water droplets entrained within the steam as it bubbles through the liquid phase. The water droplets need to be removed from the steam prior to using it in high-temperature solid oxide electrolysis. Any liquid water entrained within the steam may cause corrosion in a solid oxide electrolysis cell unit. In addition, any impurities present in the raw water feed which are not caught in the demineralizer, will accumulate in the liquid phase of the combined vessel (boiler water, BW) and such impurities may also be detrimental to the solid oxide electrolysis cell unit. The vapour phase above the liquid phase will comprise dried steam of which a part will be directed to the stripper and a part will exit the combined vessel to form a dried process steam useful in various processes, and in particular useful in high-temperature solid oxide electrolysis.

In one embodiment of the water treatment system according to the invention, the combined vessel comprises a process steam outlet arranged in the upper part of the combined vessel (22). The combined vessel (22) may further comprise a demister (36) arranged above the combined vessel (22) and in fluid communication with the process steam outlet. A demister is a device often fitted to vapor-liquid separator vessels to enhance removal of liquid droplets entrained in a product steam.

Any impurities present in the raw water feed which are not caught in the demineralizer, will accumulate in the liquid phase of the combined vessel (boiler water, BW). Therefore, it may be necessary to repeatedly or continuously discard a small fraction of the liquid phase within the combined vessel. In one embodiment of the water treatment system according to the invention, the combined vessel (22) comprises a purge outlet (37) in lower part of the vessel.

In one embodiment of the water treatment system according to the invention, the direct fluid communication between the combined vessel and the stripper accommodates recirculation (23, 24) of fluid between the combined vessel (22) and the stripper (21).

In one embodiment of the water treatment system according to the invention, the heating arrangement comprises heat exchangers (32) arranged below and in direct fluid communication (33,34) with said combined vessel (22) for indirect transfer of heat to any fluid flowing to and from the heat exchangers (32). In one embodiment of the water treatment system according to the invention, the heating arrangement comprises a heating coil (44) arranged within and in the lower part of said combined vessel (22) for indirect transfer of heat to any fluid within the combined vessel (22). The heating arrangement may comprise both heating elements in the form of heat exchangers arranged below and in direct fluid communication (33,34) with said combined vessel and heating elements in the form of heating coils arranged within and in the lower part of said combined vessel (22).

The combined vessel may be arranged vertically or horizontally as required.

### Demineralizer

In the context of water treatment, the first step will generally be to pass a raw feed stream through a demineralizer to remove minerals and other impurities from the raw water feed thus producing demineralized water (may be referred to as DMW). A demineralizer generally comprises one or more ion exchange columns thus removing impurities by ion exchange. However other ways of removing ions may be envisaged. In one embodiment of the water treatment system according to the invention, the system further comprises a demineralizer (11) upstream of and in fluid communication with the stripper (21).

### Process Control Arrangement

In one embodiment of the water treatment system according to the invention, the system further comprises a process control arrangement for controlling operation of the water treatment system. In order to operate the system with good results it is preferred that the system includes means for controlling the various flows, pressures and temperatures within the system. The process control arrangement may also comprise a computer program for obtaining operating parameters for the water treatment system, comparing them to preset values, and adjusting actual settings according to the computer programme.

### The Process

Disclosed herein is a water treatment process as defined above.

In one embodiment of the water treatment process according to the invention, the operating pressure within the combined vessel is within the range of from 0.7-10 bar abs, such as from, or 0.9-8, or 1-7 bar abs.

In one embodiment of the water treatment process according to the invention, In one embodiment of the water treatment system according to the invention, the oxygen depleted, dried process steam is exposed to a subsequent step of demisting.

In one embodiment of the water treatment process according to the invention, an additional oxygen depleted steam from an external source is added to the liquid part of the water-steam mixture within the combined vessel. If the additional oxygen depleted steam from an external source is of high purity, it may be added directly into the combined vessel. Otherwise it may be passed through a heating coil to provide indirect heating.

### Use of the Water Treatment System

In an embodiment the water treatment system according to the invention is used in a plant using steam as a feed.

In an embodiment a process is provided for producing hydrogen comprising:
Producing oxygen depleted, dried process steam according to the invention;
Feeding the oxygen depleted, dried process steam to a solid oxide electrolysis cell and performing high temperature electrolysis within the cell to produce a hydrogen rich product gas.

In addition to the oxygen depleted, dried process steam a feed comprising carbon dioxide and/or carbon monoxide may be fed to the solid oxide electrolysis cell performing the high temperature electrolysis.

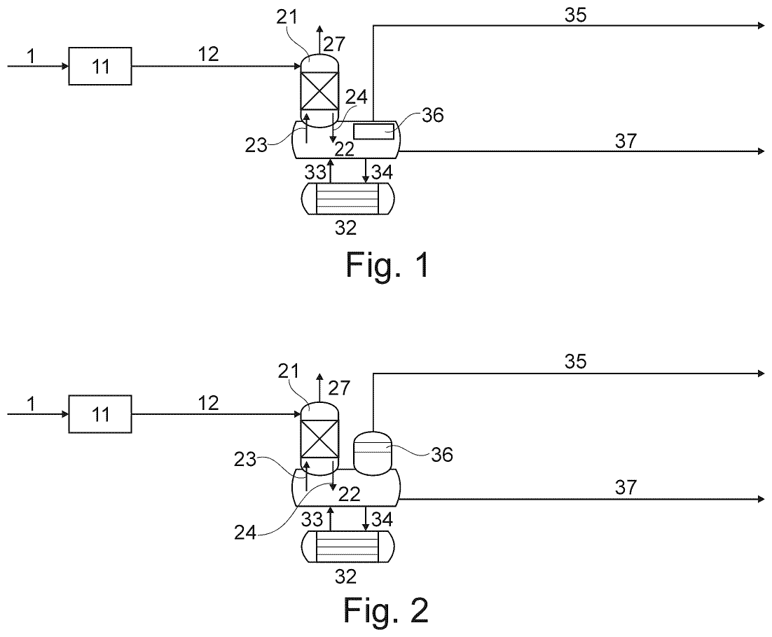

In FIG. 1, a raw water stream (1) is demineralized in an ion exchanger (11) to obtain demineralized water (12) with a very low content of minerals. The demineralized water may be abbreviated DMW. The demineralized water might still contain some oxygen and is sent to a vertically arranged stripper (21) comprising a packed bed where the oxygen is stripped from the water using steam (23). Oxygen and steam leave the vessel in the top (27) and oxygen depleted water leaves the vessel in the bottom below the packed bed (24). The demineralized, oxygen depleted water is collected in a horizontally arranged combined vessel (22) below the packed bed. The demineralized, oxygen depleted water collected in the combined vessel may be referred to as boiler water (BW). The boiler water is circulated (34) to a heat exchanger (32) arranged below the combined vessel (22) in which steam is generated and a steam-water mixture is recirculated (33) to the combined vessel (22). The boiler water forms a liquid phase which covers at least the bottom of the combined vessel (22) and the heating surfaces of the heat exchanger (32). The recirculated steam-water mixture is bubbled through the liquid phase in the combined vessel separating water from the steam-water mixture producing a phase of dried steam above the liquid phase within the combined vessel (22). The dried steam is fed (23) to the stripper (21) and to a demister (36) arranged in the top of the combined vessel (22). The demister reduces carryover of liquid water droplets to the steam and a demineralized, oxygen depleted, dried steam (35) is collected from the demister (36), which may be used in any process requiring demineralized, oxygen depleted, dried steam, such as in a SOEC system.

In order to avoid that the remaining salts are building up in the boiler water of the combined vessel (22) a small flow (37) is purged from the liquid phase of the boiler water. This purge may be referred to as blowdown.

The combined vessel (22) is operated at a pressure in the range of from 1-8 bar abs and the flow of raw water to the water treatment system (1), the flow of dried, oxygen depleted steam from the water treatment system as well as the heat supplied to the heat exchanger are controlled such that the boiler water forms a liquid phase which covers at least the bottom of the combined vessel and the heating surfaces of the heat exchanger.

In FIG. 2, a water treatment system similar that of FIG. 1 is illustrated except the demister (36) is arranged in a separate vessel placed on top of the surge vessel.

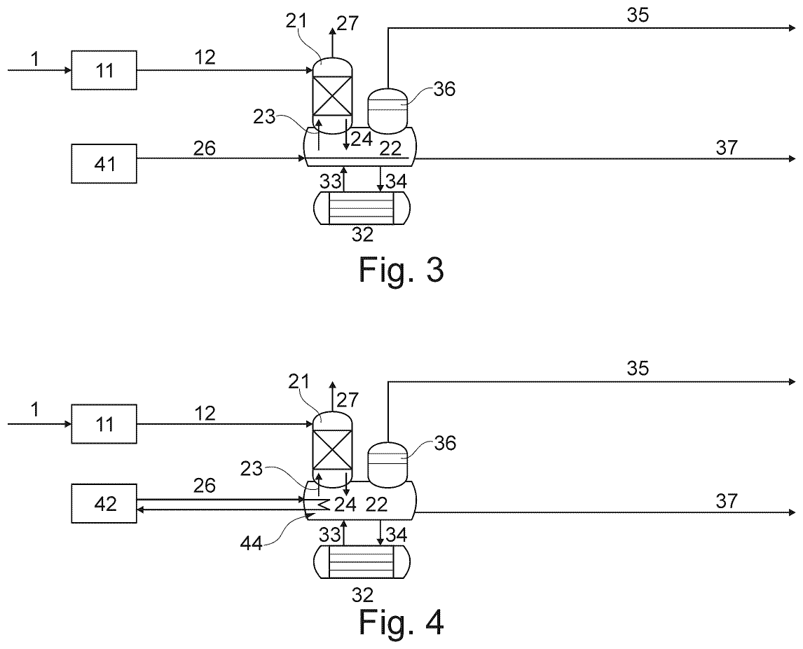

In FIG. 3, a water treatment system similar that of FIG. 2 is illustrated except steam produced by an external process (41) is fed to the liquid phase of the boiler water in the combined vessel (22).

In FIG. 4, a water treatment system similar that of FIG. 2 is illustrated except hot process gas such as steam from an external process (42) is passed through a heating coil within the liquid phase of the boiler water within the combined vessel (22) to transfer heat from the hot process gas to the boiler water by indirect heat transfer.

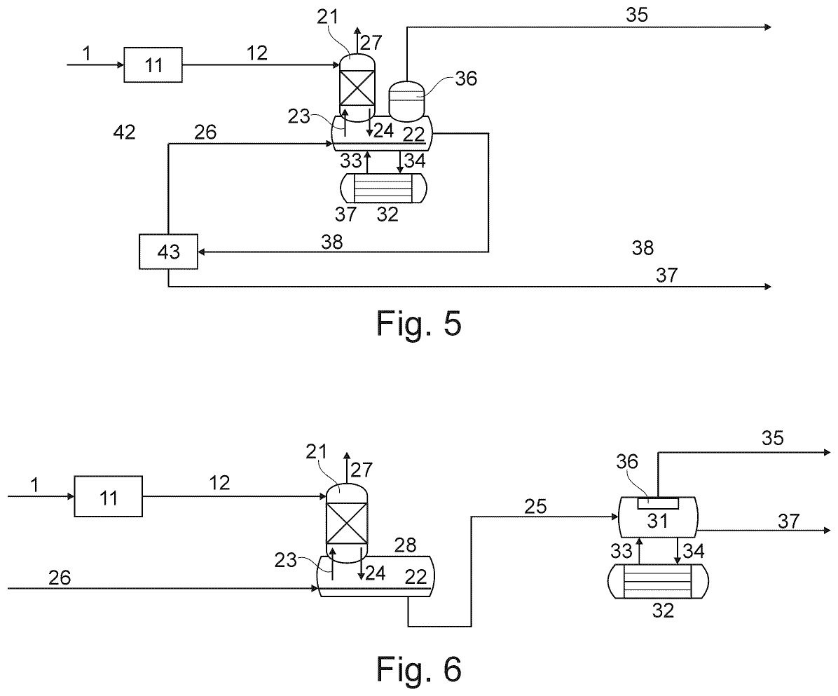

In FIG. 5, a water treatment system similar that of FIG. 2 is illustrated except the purge (37) from the combined vessel (22) is fed to an external boiler (43) and the steam generated is recycled to the liquid phase of the boiler water in the combined vessel (22).

In FIG. 6, a representative prior art water treatment system is shown, wherein a raw water stream (1) is demineralized in a ion exchanger (11) and the purified water having a very low content of minerals may be referred to as demineralized water DMW (12). The demineralized water might still contain some oxygen and is sent to a stripper (21) with a packed bed where the oxygen is stripped from the water using steam (23). Oxygen and steam is leaving the vessel in the top and demineralized, oxygen depleted water leaves (24) the stripper (21) in the bottom below the packed bed. The oxygen depleted and demineralized water now referred to as boiler feed water BFW is collected in a surge vessel (28) below the packed bed. The main purpose of the surge vessel is to contain a buffer volume of BFW. In order to keep the BFW at the boiling point in the surge vessel (28) and to generate the steam (23) needed for the stripper 21, then heat is added to the surge vessel directly by injecting steam from external source (26) into the surge vessel (28). The steam (23) may alternatively be added indirectly with heat exchange with a coil in the surge vessel.

The stripper (21) with the packed bed is in this embodiment integrated with the surge vessel and may be referred to as a “deaerator”. The deaerator is operated at a pressure in the range 1 bar abs to 5 bar abs.

The BFW (25) is pumped from the surge vessel (28) to the boiler. The boiler comprises a heat exchanger (32) in which the steam is generated and a vessel for separation of the mixture of steam and water coming from the heat exchanger referred to as a “steam drum” (31). The steam drum (31) is connected to the heat exchanger(s) with piping for water (34) and for steam/water mixture (33). Alternatively, the steam drum and heat exchanger may be integrated or a combination of the two alternatives. A demister (36) is arranged in the top of the steam drum (31) serves to reduce carryover of liquid water droplets to the steam leaving the steam drum, which may be supplied to consumers.

In order to avoid that the remaining salts are building up in the boiler water in the steam drum (31) and the heat exchanger (32) a small flow (37) is purged from the liquid phase of the steam drum (31).

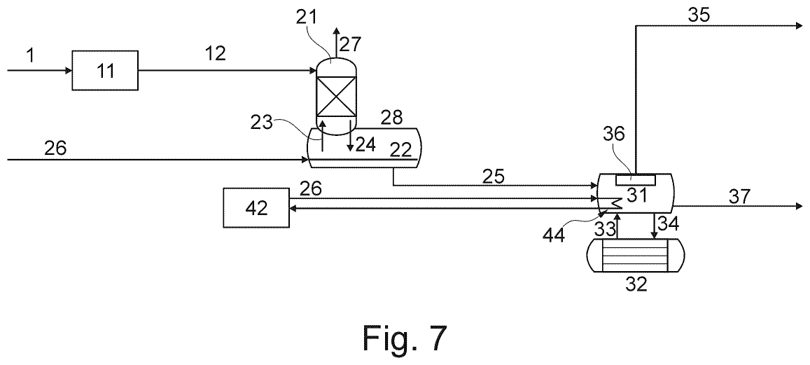

In FIG. 7, a representative prior art water treatment system similar that of FIG. 6 is illustrated except hot process gas such as steam from an external process (42) is passed through a heating coil within the liquid phase of the boiler water within the combined vessel (22) to transfer heat from the hot process gas to the boiler water by indirect heat transfer.

### EXAMPLE

Example 1: A High-Temperature Solid Oxide Electrolysis System with a Water Treatment System Comprising a Combined Vessel

In FIG. 2 an embodiment of the invention is described. A raw water stream (1) of 21.8 m3 per hour is demineralized in an ion exchanger (11) containing acidic and alkaline ion exchange resins. The demineralized water DMW (12) is fed to a stripper (vertical vessel) comprising a packed bed (21) of 25 mm IMTP random packings where the oxygen is stripped from the water using steam (23) delivered below the packed bed. 100 kg/h

Oxygen and steam leaves the vessel from the top of the stripper (27) and the oxygen depleted water produced leaves the vessel at the bottom below the packed bed (24). The oxygen depleted water is collected in a combined vessel (22) below the packed bed. The combined vessel serves to contain a buffer volume of oxygen depleted water which may be referred to as boiler water. The boiler water is kept at the boiling point in the combined vessel (22) by supplying indirect heat from a heat exchanger (32) placed below the combined vessel. The colder and heavier water sinks to the bottom of the combined vessel and passes to the heat exchanger through an opening (34). The heat exchanger delivers heat to the boiler water at a rate of 11.5 MW. The steam generated in the heat exchanger (32) passes through an opening (33) to the combined vessel. The combined vessel serves to deliver steam to the bottom of the stripper and to remove liquid water droplets caught within the steam in a demister (36) arranged above the combined vessel. An oxygen depleted, dried process steam is withdrawn from the demister (35) at a rate of 21.5 t/h to produce 20000 Nm3/h H2.

In order to avoid that the remaining salts are building up in the combined vessel a flow of 200 kg/h is purged from the liquid fase (37). The oxygen depleted, dried process steam is fed to SOEC stacks operating at 2 bar g and 750° C.

Such a system has an advantage of enabling the construction of a simplified system for producing H₂ from steam, thus reducing the construction costs of the system. Less metal is required for the reactors and less instruments are needed for controlling the operation of the system.

1. A water treatment system for preparing an oxygen depleted, dried process steam comprising:
a stripper for stripping oxygen from water;
a fluid collector vessel for collecting oxygen depleted, liquid water from the stripper;
a fluid separator vessel for collecting a liquid water-steam mixture and for separating water from steam;
a heating arrangement for vaporizing liquid water to steam; and
wherein said fluid collector and said fluid separator are provided as a combined vessel for collecting oxygen depleted liquid water from the stripper and for separating water and steam; and
wherein said stripper is arranged above and in direct fluid communication with said combined vessel; and
wherein said heating arrangement is arranged to provide steam to the lower part of the combined vessel.

2. The water treatment system according to claim 1, wherein the heating arrangement comprises a heating element arranged below and in direct fluid communication with said combined vessel.

3. The water treatment system according to claim 1, wherein the heating arrangement comprises a heating element arranged within and in the lower part of the combined vessel.

4. The water treatment system according to claim 1, wherein the combined vessel comprises a process steam outlet arranged in the upper part of the combined vessel.

5. The water treatment system according to claim 4, wherein the combined vessel further comprises a demister arranged above the combined vessel and in fluid communication with the process steam outlet.

6. The water treatment system according to claim 1, wherein the combined vessel comprises a purge outlet in lower part of the vessel.

7. The water treatment system according to claim 1, wherein the direct fluid communication between the combined vessel and the stripper accommodates recirculation of fluid between the combined vessel and the stripper.

8. The water treatment system according to claim 1, wherein the stripper comprises a packed bed, baffles and other internals to accommodate stripping of oxygen from liquid water within the stripper.

9. The water treatment system according to claim 1, wherein the stripper further comprises a liquid water inlet arranged in the upper part of the stripper.

10. The water treatment system according to claim 1, wherein the stripper further comprises a vapor outlet arranged in the upper part of the stripper.

11. The water treatment system according to claim 1, wherein the heating arrangement comprises heat exchangers arranged below and in direct fluid communication with said combined vessel for indirect transfer of heat to any fluid flowing to and from the heat exchangers.

12. The water treatment system according to claim 1, wherein the heating arrangement comprises a heating coil arranged within and in the lower part of said combined vessel for indirect transfer of heat to any fluid within the combined vessel.

13. The water treatment system according to claim 1, wherein the boiler water is circulated to a heat exchanger arranged below the combined vessel in which steam is generated and a steam-water mixture is recirculated to the combined vessel.

14. The water treatment system according to claim 1, further comprising a demineralizer upstream of and in fluid communication with the stripper.

15. The water treatment system according to claim 1, further comprising a process control arrangement for controlling operation of the water treatment system.

16. A water treatment process for producing an oxygen depleted, dried process steam comprising the steps of:
stripping oxygen from a demineralized water stream by passing it over a packed bed and passing oxygen stripping steam in a counter current direction to produce oxygen depleted water;
collecting the oxygen depleted water in a combined vessel to obtain an oxygen depleted water-steam mixture within the combined vessel;
indirectly heating a liquid part of the water-steam mixture to produce wet steam;
removing water droplets from the wet steam by bubbling the steam through the liquid part of the water-steam mixture to produce dried steam;
wherein the oxygen depleted water-steam mixture within the combined vessel serves to supply the oxygen stripping steam to the stripper, to buffer variations in the demineralized water stream per dried steam produced, to absorb differences in pressure upstream versus downstream of the combined vessel, and to remove water droplets from the wet steam;
to produce the oxygen depleted, dried process steam.

17. The process according to claim 16, wherein the operating pressure within the combined vessel is within the range of from 0.7-10 bar abs.

18. The process according to claim 16, wherein oxygen depleted, dried process steam is exposed to a subsequent step of demisting.

19. The process according to claim 16, wherein oxygen depleted steam from an external source is added to the liquid part of the water-steam mixture within the combined vessel.

20. A method of using the apparatus according to claim 1 in a plant using steam as a feed.

21. A process for producing hydrogen comprising:
producing oxygen depleted, dried process steam according to claim 16;
feeding the oxygen depleted, dried process steam to a solid oxide electrolysis cell and performing high temperature electrolysis within the cell to produce a hydrogen rich product gas.

22. The process according to claim 21, wherein in addition to the oxygen depleted, dried process steam, a feed comprising carbon dioxide and/or carbon monoxide is fed to the solid oxide electrolysis cell performing the high temperature electrolysis.
